(19) United States
(12) Patent Application Publication
(10) Pub. No.: US 2026/0078688 A1
(43) Pub. Date: Mar. 19, 2026

(54) MOUNTING ACOUSTIC SANDWICH PANEL

(71) Applicant: SAFRAN NACELLES, Gonfreville-L'Orcher (FR)

(72) Inventor: Romain BILLAULT-CHAUMARTIN, Moissy-Cramayel (FR)

(73) Assignee: SAFRAN NACELLES, Gonfreville-L'Orcher (FR)

(21) Appl. No.: 19/329,816

(22) Filed: Sep. 16, 2025

(30) Foreign Application Priority Data
Sep. 18, 2024 (FR) FR2409947

(51) Int. Cl. F01D 25/24

(52) U.S. Cl. CPC F01D 25/243; F05D 2260/96

(57) ABSTRACT

An acoustic panel including a first skin and a second skin extending on either side of an acoustic core, the acoustic panel also includes a flank connecting the first skin and the second skin and which has an outer flank face, the acoustic panel includes at least one threaded portion extending in a direction substantially orthogonal to a first plane containing the outer flank face. An assembly including such a panel.

### TECHNICAL FIELD OF THE INVENTION

The present invention relates to the field of acoustic-insulation sandwich panels, and more specifically to the use of such panels in turbojet engine nacelles.

It relates more specifically to the junction of an air inlet on the nacelle casing, also referred to as fan casing in the case of a bypass turbine engine.

The invention applies to all turbine engine designs, for example, turbojet engines driven directly by a low-pressure spool, driven indirectly by a reduction gear, single-spool, twin-spool, single-flow and bypass turbojet engines.

### PRIOR ART

In a turbine engine, here a turbojet engine of central axis AX, air is admitted, in a longitudinal direction parallel to the axis AX, into an inlet duct to pass through a fan comprising a series of rotary blades before splitting into a central primary flow which flows in a so-called flow path of a primary airflow and a secondary flow surrounding the primary flow.

The primary flow is compressed by compressor stages before reaching a combustion chamber, after which it expands by passing through turbines, before being discharged while generating a thrust. The secondary flow is for its part propelled directly by the fan to generate the main thrust.

The turbojet engine also comprises a nacelle which supports the turbojet engine elements and provides the connection of the turbojet engine to the aircraft. The nacelle comprises a fan casing at the upstream end of which an air inlet—also referred to as air inlet lip—is mounted. The air inlet conventionally comprises an annular structure and a substantially transverse rear partition which connects a radially inner fairing and a radially outer fairing of the annular structure. Aircraft noise emission reduction requirements have led to the installation of acoustically treated panels to define the radially internal fairing (that which is in contact with the air inlet flow) of the air inlet.

These panels, of the sandwich type, are generally composite structures that consist of two rigid outer skin layers (most often made of aluminum or composite materials) and a light central core, often made of materials such as foam or honeycomb. The acoustic treatments applied to these panels aim to improve their noise attenuation performance, which is crucial for passenger comfort and compliance with environmental regulations.

There are three main types of acoustically treated sandwich panel: SDOF (Single Degree of Freedom) panels, 2DOF (Double Degree of Freedom) panels, and multilayer panels.

SDOF (Single Degree of Freedom) sandwich panels are designed with a single acoustic resonance mechanism. These panels consist of two layers of skin and a homogeneous core. Their acoustic performance is mainly determined by core density and skin thickness. These panels are easy to manufacture and are often used in applications where moderate noise attenuation is sufficient.

2DOF (Double Degree of Freedom) sandwich panels incorporate two acoustic resonance mechanisms, providing better attenuation performance over a wider frequency range. This type of panel usually has two different core layers separated by an intermediate layer, which makes it possible to effectively handle low and high frequencies. 2DOF panels are more complex to manufacture but offer significant noise reduction benefits.

Multilayer sandwich panels comprise multiple layers of cores and skins, enabling very fine acoustic control. These structures can be customized to meet specific noise attenuation needs at various frequencies. Their manufacturing complexity is high, but they offer the best acoustic performance among sandwich panel types.

The skins of sandwich panels are generally made of composite or metal materials. Composite materials often consist of resin-impregnated carbon or glass fibers, while metal skins are typically aluminum or titanium. Skin production requires formation processes such as vacuum molding, autoclaving or thermoforming.

The cores, on the other hand, can be made from materials such as polymer foam, honeycomb structures or alveolar materials. Polymer foam is produced by molding or extrusion, while honeycomb structures are obtained by rolling and expanding. Honeycomb materials can be produced by extrusion or injection.

The assembly of the sandwich panel components is typically done by gluing, using structural adhesives capable of maintaining the mechanical and acoustic integrity of the structure. Assembly processes may include hot pressing, vacuum bonding, and the use of mechanical fasteners to strengthen adhesion. Some panels may also incorporate a metal honeycomb core brazed onto metal skins.

Traditionally, sandwich panels are joined together by specific bonding or welding techniques, ensuring structural and acoustic continuity. The adhesives used must offer excellent fatigue strength and resistance to aerospace service environments.

For connections between sandwich panels and non-sandwich elements (such as metal or monolithic composite structures), bonding, bolting or riveting techniques can be used. For the latter two techniques, a flange-type assembly is produced which comprises a first flange and a second flange whose respective connection faces are in put in contact. A bolt or rivet is engaged through the aligned holes of the two flanges to then exert a joining force on bearing faces of each flange opposite to the connecting faces.

For parts of revolution, the shaping of these flanges requires bending the radially outer skin so that it meets the radially inner skin, and, at a distance from this joint, bending the radially inner skin again at ninety degrees to create the flange. This creates an area without an acoustic core and whose axial length corresponds at least to the length of the screw, rivet or clamping or riveting tool. This area reduces the surface area of the sandwich panel which is acoustically treated. Finally, the shaping of the flange and the joining of the skins implement complex and costly panel-manufacturing techniques.

### DISCLOSURE OF THE INVENTION

The aim of the present invention is to improve the acoustic insulation of a composite panel structure assembled with an element of a different nature and to reduce the costs of such an assembly.

For this purpose, an acoustic panel is provided comprising a first skin and a second skin extending on either side of an acoustic core, the acoustic panel also comprising a flank connecting the first skin and the second skin and which has an outer flank face. According to the invention, the acoustic panel comprises at least one threaded portion extending in a direction substantially orthogonal to a first plane containing the outer flank face.

According to other particular, non-exclusive and optional embodiments of the invention:
the acoustic panel is in the shape of a sector of a part of revolution;
the acoustic panel comprises an insert that carries the threaded portion;
the insert extends across the flank;
the insert comprises an outer insert face extending in the first plane;
the insert comprises an outer insert face that comes into contact with an inner flank face of the flank;
the insert comprises a housing for accommodating a barrel nut;
the barrel nut extends through the first skin and/or the second skin;
the flank extends orthogonally to the first skin and/or to the second skin.

The invention also relates to an assembly of an acoustic panel as defined above on a flange of an element, wherein the outer flank face is in contact with a connecting face of the flange, a threaded body extending through the flange and the flank to cooperate with the insert and apply a bearing force of the flange on the flank.

Other features and advantages of the invention will appear upon reading the following description of particular non-limiting embodiments of the invention.

### BRIEF DESCRIPTION OF THE FIGURES

The invention will be better understood upon reading the following description, given as a non-limiting example, and made with reference to the figures which represent:

FIG. 1 is a schematic sectional representation of a turbojet engine equipped with an acoustic panel according to the invention;

FIG. 2 is a detailed schematic partial representation in longitudinal section of an air inlet equipped with an acoustic panel according to a first embodiment of the invention;

FIG. 3 is a schematic perspective representation of an acoustic panel according to a first embodiment of the invention;

FIG. 4 is a detailed schematic partial representation in longitudinal section of an assembly comprising the acoustic panel of FIG. 2 devoid of the fastening screws;

FIG. 5 is a detailed schematic partial representation in longitudinal section of an assembly comprising the acoustic panel of FIG. 2 provided with the fastening screws;

FIG. 6 is a detailed schematic partial representation in longitudinal section of an assembly comprising an acoustic panel according to a second embodiment of the invention and which is devoid of the fastening screws;

FIG. 7 is a detailed schematic partial representation in longitudinal section of an assembly comprising an acoustic panel according to the second embodiment of the invention provided with the fastening screws;

FIG. 8 is a detailed schematic partial representation in longitudinal section of an assembly comprising an acoustic panel according to a third embodiment of the invention and which is devoid of the fastening screws;

FIG. 9 is a detailed schematic partial representation in longitudinal section of an assembly comprising an acoustic panel according to the third embodiment of the invention provided with the fastening screws;

FIG. 10 is a detailed schematic partial representation in tangential section of an assembly comprising an acoustic panel according to the third embodiment of the invention and which is provided with the fastening screws.

### DESCRIPTION OF THE EMBODIMENTS

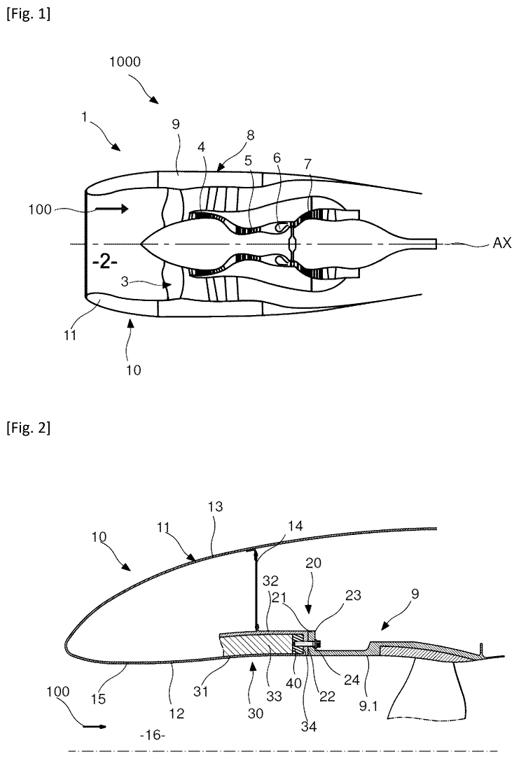

With reference to FIGS. 1 and 2, a propulsion unit 1000 comprises a turbine engine, here a turbojet engine generally referenced 1, wherein an airflow 100 is admitted, in a longitudinal direction parallel to the axis AX of rotation of the turbine engine 1, into an inlet duct 2 to pass through a fan including a series of rotary blades 3.

Part of the airflow 100 is compressed by compressor stages 4 and 5 before reaching a combustion chamber 6, after which it expands by passing through turbines 7, before being discharged while generating a thrust. The remainder of the airflow 100 is for its part propelled directly by the fan to generate the main thrust.

Herein, the terms “internal” and “external” are used with reference to the position or orientation relative to the axis of rotation of the turbines 7.

Herein, the terms “upstream” and “downstream” are used with reference to the position or orientation of an element in the flow direction of the airflow 100 in the turbojet engine 1.

As a preliminary measure, there are defined an axial direction, a radial direction which is orthogonal to the axial direction and a circumferential/tangential direction which is orthogonal to the axial and radial directions.

The turbojet engine 1 also comprises a nacelle 8 which supports the elements of the turbojet engine 1 and provides its connection to an aircraft, not shown. The nacelle 8 comprises a fan casing 9 wherein the upstream end particularly comprises an upstream casing flange 20 on which an air inlet 10 is mounted. The upstream flange 20 comprises a web 21 which extends radially from the casing 9 outward. The web 21 comprises an upstream connection face 22 and a downstream bearing face 23. A plurality of holes 24 extend through the web 21 to connect the connection face 22 and the bearing face 23.

The air inlet 10 comprises an annular structure 11 of longitudinal axis coincident with the axis AX and comprises an inner fairing 12 and an outer fairing 13.

As seen in FIG. 2, the inner bearing 12 delimits a radially outer wall 15 of a flow path 16 of the airflow 100. The internal fairing 12 is, here, made of a sandwich-type acoustic panel 30.

Hereinafter in the description, the parts being parts of revolution or sectors of such parts, only a cross-section will be described, it being understood that such a cross-section is conventionally repeated according to a rotation of longitudinal axis AX.

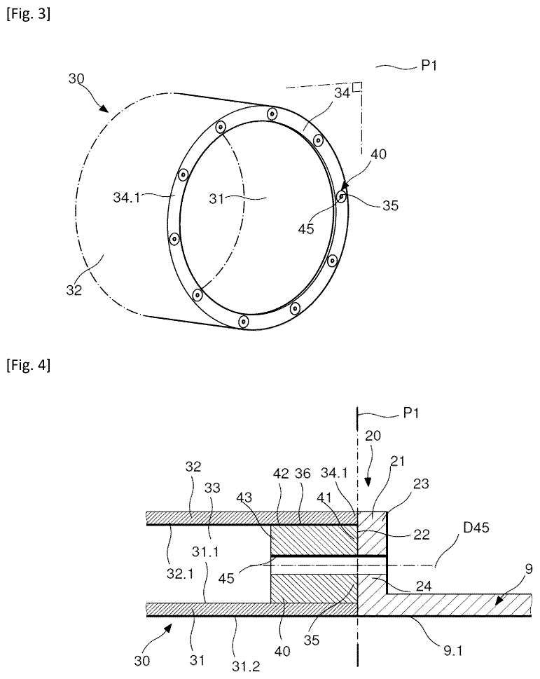

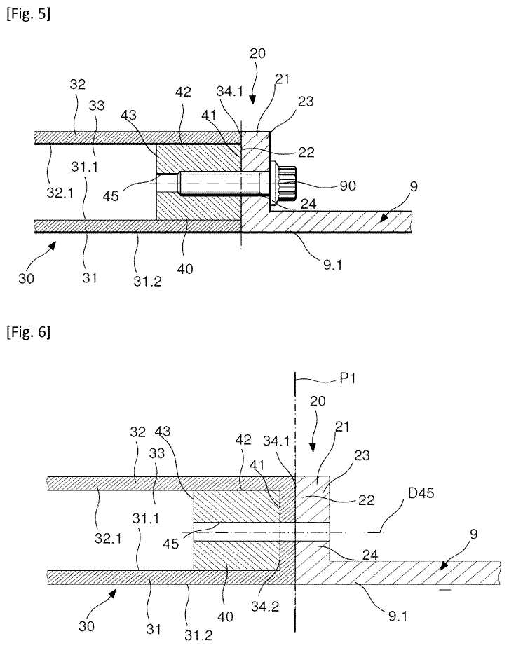

With reference to FIGS. 2 to 5, the acoustic panel 30 is herein in the shape of a straight cylinder and comprises a first inner skin 31 and a second outer skin 32 extending on either side of an acoustic core 33. The panel 30 also comprises a downstream flank 34 connecting the inner skin 31 and the outer skin 32. The flank 34 has an outer face 34.1 of the flank 34 which extends in a first radial plane P1. An insert 40 extends into a cylindrical aperture 35 made through the flank 34 and into a housing 36 made in the core 33. The insert 40 is in the shape of a straight cylinder and comprises an outer face 41 of the insert 40—here a downstream face—connected by a cylindrical wall 42 to an inner face 43—here an upstream face. According to this first embodiment, the outer face 41 extends in the plane P1. As the aperture 35 here has a diameter substantially equal to the thickness of the core 33, the faces 41 and 43 each extend between an inner face 31.1 of the inner skin 31 and an inner face 32.1 of the outer skin 32.

As can be seen in FIG. 4, the insert 40 comprises a threaded portion—here a tapped bore 45—which extends along a direction D45 substantially orthogonal to the first plane P1, i.e. an axial direction. The panel 30 comprises ten inserts identical to the insert 40 and distributed thirty-six degrees apart from each other.

The panel 30 can be manufactured according to the following steps:
a) forming the inner skin 31;
b) forming the outer skin 32;
c) forming the acoustic core 33;
d) forming the flank 34;
e) assembling and securing the skins 31 and 32 with the flank 34 and the core 33 according to methods known to those skilled in the art;
f) making the aperture 35 and the housing 36 by axial drilling;
g) placing glue in the housing 36;
h) mounting the insert 40 in the housing 36 through the aperture 35. Operations f) to h) are repeated as many times as the panel 30 comprises inserts 40.

Alternatively, the creation of the apertures 35 can take place prior to the forming of the inner skin 31. The housings 36 may also be made in the core 33 prior to its assembly with the skins 31 and 32.

The panel 30 is assembled on the flange 20 of the casing 9 by bringing into contact the outer face 34.1 of the flank 34 with the connection face 22 of the flange 20. Screws 90 are then engaged in the holes 24 to extend through the flange 20 and cooperate with the tapped bores 45. Screwing the screws 90 into the tapped bores 45 makes it possible to apply a bearing force of the face 34.1 of the flank 34 on the face 23 of the flange 20 to assemble the flange 20 on the flank 34, and thus connect the air inlet 10 to the casing 9.

This results in a simple, reliable flange connection, which is cost-effective to implement and allows the acoustic protection surface to be optimized. Finally, using a reduced number of parts, the invention makes it possible to guarantee continuity of the internal fairing of the flow path 16. This is because the outer face 31.2 of the inner skin 31 comes into continuity with the inner face 9.1 of the housing 9.

Elements that are identical or similar to those described above will bear a reference numeral that is identical thereto in the description of a second and a third embodiment of the invention given below.

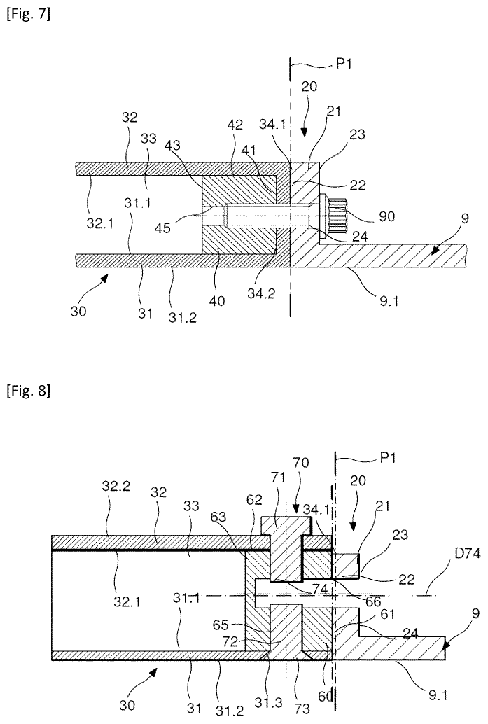

According to a second embodiment of the invention shown in FIGS. 6 and 7, the outer face 41 of the insert 40 comes into contact with an inner flank face 34.2 of the flank 34. The insert 40 is then mounted in the core 33 prior to the assembly thereof with the skins 31 and 32 as well as the flank 34. The assembly of the panel 30 on the flange 20 is carried out according to identical methods to those described above.

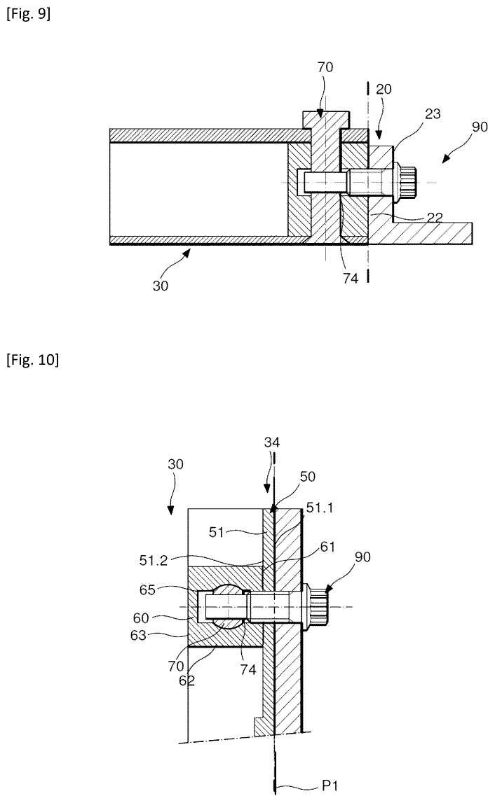

According to a third embodiment shown in FIGS. 8 to 10, the flank 34 consists of ten segments 50 of a flank 34. Each segment 50 comprises an flank element 51 in the form of an annular sector with an amplitude of thirty-six degrees, which comprises an outer face 51.1 extending in the plane P1. Each segment 50 comprises an insert 60 which is attached to an inner face 51.2 of the flank element 51.

The insert 60 is in the shape of a straight cylinder and comprises an outer face 61 of the insert 60—here a downstream face—connected by a cylindrical wall 62 to an inner face 63—here an upstream face that comes into contact with the inner face 51.2. The faces 61 and 63 each extend between the inner face 31.1 of the inner skin 31 and the inner face 32.1 of the outer skin 32.

The insert 60 defines a cylindrical housing 65 for receiving a barrel nut 70. The housing 65 extends between the inner skin 31 and the skin 32 and opens onto each of the skins 31 and 32. The barrel nut 70 is here in the form of a straight cylinder and extends through the inner skin 31 and the outer skin 32. More specifically, the barrel nut 70 comprises a head 71 that projects from the outer surface 32.2 of the outer skin 32. The body 72 of the barrel nut 70 extends into the housing 65 to pass through the inner skin 31. The end 73 of the barrel nut 70 is deformed by riveting to extend into a milling 31.3 of the inner skin 31. The body 72 comprises a threaded portion 74 which extends along a direction D74 substantially orthogonal to the plane P1. The insert 60 also comprises a bore 66, orthogonal to the housing 65, which extends in continuity with the threaded portion 74 to open onto the flank 34.

The panel 30 is assembled on the flange 20 of the casing 9 by contacting the outer face 34.1 of the flank 34 with the connection face 22 of the flange 20. Screws 90 are then engaged in the holes 24 to extend through the flange 20 and the bore 66 and cooperate with the threaded portions 74. Screwing the screws 90 into the threaded portions 74 makes it possible to apply a bearing force of the face 34.1 of the flank 34 on the face 23 of the flange 20 to assemble the flange 20 on the flank 34, and thus connect the air inlet 10 to the casing 9. The clamping force applied by the screws 90 is transmitted by the barrel nuts 70 directly to the inner skin 31 and the outer skin 32 without stressing the connection—generally carried out by gluing—of the insert 60 to the skins 31 and 32.

It goes without saying that the invention is not limited to the embodiments described, but encompasses any variant that falls within the scope of the invention as defined by the claims.

In particular:
although here the acoustic panel is in the form of a straight cylinder and thus describes a cylinder sector of three hundred and sixty degrees, the invention also applies to other configurations of the acoustic panel such as for example an acoustic panel in the form of a cylinder sector of ninety degrees, four sectors being then necessary to define the complete cylindrical envelope of the air inlet;
although the aperture here is a circular aperture, the invention also applies to other forms of aperture such as for example a square or polygonal-shaped aperture;
although here the housing is in the form of a straight cylinder and made by drilling, the invention also applies to other forms of housing such as for example a polygonal or non-circular housing in order to be able to block a rotation of the insert about itself about an axial axis, the housing being able to be made by machining, laser cutting, etc.;
although here the insert is fixed by gluing in the panel, the invention also applies to other means of fastening the insert to the panel such as for example fastening by screwing or riveting through the inner or outer skin, or by resining during the impregnation of the skins;
although herein the insert comprises a tapped bore cooperating with a screw, the invention also applies to other types of threaded portions cooperating with a threaded body such as for example a threaded stud integral with the insert and which cooperates with a nut;
although the panel according to the invention has been described herein in application to an air inlet, the invention also applies to other types of structure such as for example a downstream portion of the flow path;
although here the inner fairing defines the inner wall of an air flow path, the invention also applies to an inner bearing partially defining such a flow path, such as for example an inner fairing connected to another element which would also contribute to the definition of the flow path;
although here the casing and air inlet flanges are described as being circular elements of revolution, the invention also applies to flanges composed of a plurality of ring sectors;
although here the assembly of the air inlet on the housing is carried out using two flat flanges bolted or riveted together, the invention also applies to other flange-type assemblies such as for example screwed flanges or conical-edge flanges:
although the invention has been described here applied to a propulsion unit comprising a twin-spool bypass turbojet engine, the invention also applies to propulsion units comprising other types of turbine engine such as for example a propulsion unit comprising a single-spool bypass turbojet engine;
although here the flank comprises ten flank segments, the invention also applies to a different number of flank segments such as for example between one and nine or more than ten;
although here the insert is integral with the flank, the invention also applies to an insert attached to the flank which may or may not pass through the flank;
although here the barrel nut is fastened to the panel by riveting, the invention also applies to other methods of fastening the barrel nut to the panel such as screwing or gluing.

1. An acoustic panel comprising a first skin and a second skin extending on either side of an acoustic core the acoustic panel also comprising a flank connecting the first skin and the second skin and which has an outer flank face wherein the acoustic panel comprises at least one threaded portion located between the first skin and the second skin and extending in a direction substantially orthogonal to a first plane containing the outer flank face.

2. The acoustic panel according to claim 1, wherein the acoustic panel is shaped as a sector of a part of revolution.

3. The acoustic panel according to claim 1, wherein the flank extends orthogonally to the first skin and/or to the second skin.

4. The acoustic panel according to claim 1, comprising an insert that carries the threaded portion.

5. The acoustic panel according to claim 4, wherein the insert extends through the flank.

6. The acoustic panel according to claim 5, wherein the insert comprises an outer insert face extending in the first plane.

7. The acoustic panel according to claim 4, wherein the insert comprises an outer insert face that comes into contact with an inner flank face of the flank.

8. The acoustic panel according to claim 4, wherein the insert comprises a housing for receiving a barrel nut.

9. The acoustic panel according to claim 7, wherein the barrel nut extends through the first skin and/or the second skin.

10. An assembly of an acoustic panel according to claim 4 on a flange of an element, wherein the outer face of the flank is in contact with a connecting face of the flange a threaded body extending through the flange and the flank to cooperate with the insert and apply a bearing force of the flange on the flank.
